(19) United States
(12) Patent Application Publication
(10) Pub. No.: US 2010/0312609 A1
(43) Pub. Date: Dec. 9, 2010

(54) Personalizing Selection of Advertisements Utilizing Digital Image Analysis

(75) Inventors: Boris Epshtein, Bothell, WA (US); Eyal Ofek, Redmond, WA (US)

Correspondence Address: SHOOK, HARDY & BACON L.L.P.;(MICROSOFT CORPORATION), INTELLECTUAL PROPERTY DEPARTMENT, 2555 GRAND BOULEVARD, KANSAS CITY, MO, 64108-2613, US

(73) Assignee: MICROSOFT CORPORATION, Redmond, WA (US)

(21) Appl. No.: 12/481,290

(22) Filed: Jun. 9, 2009

(51) Int. Cl. G06Q 30/00; G06Q 99/00; G01C 21/00; G06K 9/46; G06K 9/62

(52) U.S. Cl. 705/10; 701/300; 382/190; 382/224; 705/14.66

(57) ABSTRACT

Computer-readable media and computerized methods for automatically building a user profile from personal characteristics of a user and for leveraging the user profile to select advertisements that focus on interests of the user are provided. Building the user profile from the personal characteristics of the user involves analyzing content of media files that are directly or indirectly associated with the user. Analyzing content includes accessing a gallery of media files and scanning the media files to detect and identify features expressed by the content. These features are analyzed to abstract personal characteristics, which are aggregated to form the user profile. The type of advertisements that are selected and presented to the user are guided by the user profile. Accordingly, the selected advertisements are very relevant to the user at the time they are presented and reflect the current interests of the user.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND

In data-searching systems preceding the Web, and on the Web since its inception, search engines have employed a variety of tools to aid in organizing and presenting advertisements in tandem with search results. These tools are also leveraged to optimize the revenue received by the search engine, where optimizing revenue may be facilitated by selecting advertisements that are relevant to a user. In addition, companies that advertise strive to develop marketing models that seek to ensure that their return on advertisement investment is maximized. Maximizing the return on advertising investment may include requiring the search engine to surface relevant advertisements to the user. For instance, a search engine may be required to ascertain a subject of a query that the user has submitted during an online search and select advertisements that are relevant to the query subject. Thus, because the selected advertisement is relevant to the user, the likelihood that the user will take action (e.g., visit a website of the advertiser) based on the advertisement is increased.

However, when selecting relevant advertisements based on a subject of a query, or when employing other conventional techniques that select advertisements based on an online search, personalized aspects that are unique to the user are overlooked. For instance, although the conventional techniques may guess whether the user is a man or a woman based on a subject of a query, there is no mechanism to collect, record, and apply the gender of the user when selecting an advertisement. For instance, the search engine is not able to distinguish between a user that is a twenty year-old professional and a forty year-old homemaker who is a mother of four children if both of these users have entered a similar query. As such, these conventional techniques used by the search engine are inappropriate for targeting an advertisement to a specific user and are ineffective for optimizing revenue from advertisers. Accordingly, employing a process to collect personal characteristics of a user and to use the personal characteristics when selecting an advertisement for display, where the personal characteristics are deduced from media associated with the user, would improve the relevance of selected advertisements with respect to the user's interests and, consequently, enhance the user's experience when viewing advertisements.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Embodiments of the present invention generally relate to computer-readable media and computerized methods for building a user profile from personal characteristics of a user and for leveraging the user profile to select advertisements that focus on interests of the user. Advantageously, because the selected advertisements are very relevant to the user, ad providers are willing to pay extra for advertising space. Further, because the selected advertisements reflect the interests of the user, the user is likely to pay more attention to advertisements that are rendered during an online computing session.

Initially, building the user profile from personal characteristics of the user involves analyzing content of one or more media files (e.g., digital images, videos, audio files, email messages, online documents, and the like) that are directly or indirectly associated with the user. In embodiments, the process of analyzing content includes accessing a gallery of the media files (e.g., online photo album constructed by the user or streetside images that are publicly available), and scanning the media files to detect features expressed by content therein. By way of example, features may include a subject (e.g., person, cat, dog, etc.) of the digital image, facial features of the subject, a height of the subject, a house behind the subject, and the like. These features, or indirect evidence of the features, may be analyzed to abstract personal characteristics from the features and the indirect evidence. By way of example, abstracting personal characteristics from the features may involve deducing an age and a gender of the subject from the facial features and height, respectively, or may involve deducing the income bracket of the subject by the presence/size of the house in the background. These abstracted personal characteristics may be aggregated to form the user profile or may be incorporated into an existing user profile as an update.

By way of example, in the instance of a twenty year-old professional and a forty year-old homemaker who is a mother of four children, conventional techniques for selecting relevant advertisements may choose common advertisements for both the professional and the homemaker if they are searching for a similar item. Accordingly, the conventional techniques fail to consistently target advertisements toward users with distinct interests. However, applying the user profile to an advertisement selection process typically induces selection of advertisements that correspond with the individual interest of users. Thus, leveraging the user profile to select advertisements will consistently select advertisements for the professional that are different from the homemaker, as it is likely that these two parties do not share many interests.

In an exemplary embodiment, leveraging the user profile to select one or more advertisements initially involves identifying an opportunity to present advertisements to a user who is actively computing at a client device and capturing an identity of the user from the client device. An appropriate user profile may be accessed based on the identity of the user, where the user profile includes personal characteristics deduced from features detected in at least one media file, as discussed above. One or more of these personal characteristics may be employed to select the advertisements that target interests of the user.

Returning to the example described above, assume both homemaker and the professional post digital photos to an online website that persists the digital photos in association with the homemaker and the professional, respectively. Upon accessing and analyzing the homemaker's collection of digital photos, the reoccurring features of food and cookware may be derived from the digital photos and the personal characteristics of cooking and grocery shopping may be deduced from these features. Upon accessing and analyzing the professional's collection of digital photos, the reoccurring features of cars and travel may be derived from the digital photos and the personal characteristic of driving may be deduced from these features. Accordingly, upon each of the homemaker and the professional launching a search for the common query of “grill,” a set of advertisements related to gas and charcoal grills may surface to the homemaker while a set of advertisements related to antique or replacement car grills may be surfaced to the professional. Whereas, the conventional techniques would offer a similar set of advertisements to the homemaker and to the professional because the query was common to both.

### BRIEF DESCRIPTION OF THE DRAWINGS

The present invention is described in detail below with reference to the attached drawing figures, wherein:

FIG. 1 is a block diagram of an exemplary computing environment suitable for use in implementing embodiments of the present invention;

FIG. 2 is an illustrative digital image that shows features and indirect evidence of features within exemplary content of the digital image, where the digital image is provided in accordance with an embodiment of the present invention;

FIG. 3 is a block diagram illustrating a distributed computing environment, suitable for use in implementing embodiments of the present invention, that is configured to personalize selection of advertisements based on digital image-analysis;

FIG. 4 is an operational flow diagram of one embodiment of the present invention illustrating a high-level overview of techniques for building a user profile from personal characteristics of a user and for leveraging the user profile to select advertisements that focus on interests of the user;

FIG. 5 is a flow diagram illustrating an overall method for automatically building and maintaining a user profile by analyzing content of one or more media files, in accordance with an embodiment of the present invention;

FIG. 6 is a flow diagram illustrating an overall method for employing a user profile to select one or more advertisements that target interests of a user who is associated with the user profile, in accordance with an embodiment of the present invention; and

FIG. 7 is a flow diagram illustrating an overall method for utilizing personal characteristics to facilitate selection of one or more advertisements, in accordance with an embodiment of the present invention.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies.

Accordingly, in one embodiment, the present invention relates to computer-executable instructions, embodied on one or more computer-readable media, that perform a method for automatically building and maintaining a user profile by analyzing content of one or more media files. Initially, the method includes the step of accessing a gallery of the media files (e.g., online photo album constructed by the user or streetside images that are publicly available), which are associated with the user. Incident to accessing the gallery, the media files are scanned to detect features expressed by the content of each of the media files. In one instance, the process of scanning includes the steps of applying a set of classifiers to reveal objects in the content and comparing the objects against statistical models for the purposes of identifying the objects as one or more known features.

The method further includes abstracting personal characteristics of the user from the media files by analyzing the detected features. These personal characteristics are written to a user profile that is associated with the user. Generally, the personal characteristics of the user profile are employed to select advertisements that target interests of the user.

In another embodiment, aspects of the present invention involve a computerized method, implemented at a processing unit, for employing a user profile to select one or more advertisements that target interests of a user who is associated with the user profile. Initially, the computerized method includes a step of identifying an opportunity to present advertisements to the user while the user is currently involved in an online computing session at a client device (e.g., laptop computer, PDA, mobile device, and the like). An identity of the user is captured from the client device. Based on the user identity, the user profile associated with the identity of the user is accessed.

In embodiments, the user profile is constructed by a process that includes the following logical steps: scanning content of a plurality of digital images to detect features embodied therein; deducing personal characteristics of the user that are suggested by the detected features; and generating the user profile. Typically, the user profile reflects the personal characteristics and is persisted in association with the user. The personal characteristics of the user are applied to select the advertisements that best target interests of the user. Upon selecting the advertisements, the selected advertisements are rendered on a presentation device that is operably coupled to the client device.

In yet another embodiment, the present invention encompasses one or more computer-readable media that has computer-executable instructions embodied thereon that, when executed, perform a method for utilizing personal characteristics to facilitate selection of one or more advertisements. In an exemplary embodiment, the method includes providing one or more digital images in a collection that is linked to a user. In instances of the embodiment, the user is responsible for managing the collection. Personal characteristics that reflect interests of the user are abstracted from the digital images in the collection. In particular, the process of abstracting includes the following procedures: mining features from the digital images; gathering indirect evidence of features from the digital images; and deducing the personal characteristics from a combination of the mined features and the gathered indirect evidence of features. By way of clarification, the indirect evidence of features indicates that a specific feature is associated with a particular digital image even when the specific feature does not explicitly appear within a frame of the particular digital image. These abstracted personal characteristics are utilized to influence which of the advertisements are selected for presentation to the user. Eventually, instructions to publish the selected advertisements at a user interface (UI) display rendered by a web browser are issued.

Having briefly described an overview of embodiments of the present invention and some of the features therein, an exemplary operating environment suitable for implementing the present invention is described below.

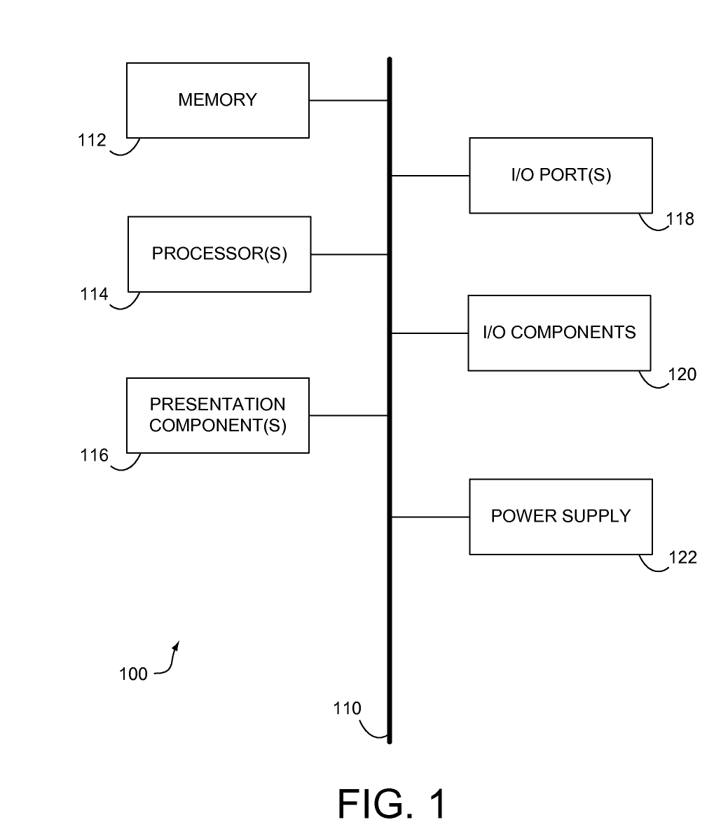

Referring to the drawings in general, and initially to FIG. 1 in particular, an exemplary operating environment for implementing embodiments of the present invention is shown and designated generally as computing device 100. Computing device 100 is but one example of a suitable computing environment and is not intended to suggest any limitation as to the scope of use or functionality of the invention. Neither should the computing device 100 be interpreted as having any dependency or requirement relating to any one or combination of components illustrated.

The invention may be described in the general context of computer code or machine-useable instructions, including computer-executable instructions such as program components, being executed by a computer or other machine, such as a personal data assistant or other handheld device. Generally, program components including routines, programs, objects, components, data structures, and the like, refer to code that performs particular tasks or implements particular abstract data types. Embodiments of the present invention may be practiced in a variety of system configurations, including handheld devices, consumer electronics, general-purpose computers, specialty computing devices, etc. Embodiments of the invention may also be practiced in distributed computing environments where tasks are performed by remote-processing devices that are linked through a communications network.

With continued reference to FIG. 1, computing device 100 includes a bus 110 that directly or indirectly couples the following devices: memory 112, one or more processors 114, one or more presentation components 116, input/output (I/O) ports 118, I/O components 120, and an illustrative power supply 122. Bus 110 represents what may be one or more busses (such as an address bus, data bus, or combination thereof). Although the various blocks of FIG. 1 are shown with lines for the sake of clarity, in reality, delineating various components is not so clear and, metaphorically, the lines would more accurately be grey and fuzzy. For example, one may consider a presentation component such as a display device to be an I/O component. Also, processors have memory. The inventors hereof recognize that such is the nature of the art and reiterate that the diagram of FIG. 1 is merely illustrative of an exemplary computing device that can be used in connection with one or more embodiments of the present invention. Distinction is not made between such categories as “workstation,” “server,” “laptop,” “handheld device,” etc., as all are contemplated within the scope of FIG. 1 and reference to “computer” or “computing device.”

Computing device 100 typically includes a variety of computer-readable media. By way of example, and not limitation, computer-readable media may comprise Random Access Memory (RAM); Read Only Memory (ROM); Electronically Erasable Programmable Read Only Memory (EEPROM); flash memory or other memory technologies; CDROM, digital versatile disks (DVDs) or other optical or holographic media; magnetic cassettes, magnetic tape, magnetic disk storage or other magnetic storage devices; or any other medium that can be used to encode desired information and be accessed by computing device 100.

Memory 112 includes computer-storage media in the form of volatile and/or nonvolatile memory. The memory may be removable, nonremovable, or a combination thereof. Exemplary hardware devices include solid-state memory, hard drives, optical-disc drives, etc. Computing device 100 includes one or more processors that read data from various entities such as memory 112 or I/O components 120. Presentation component(s) 116 present data indications to a user or other device. Exemplary presentation components include a display device, speaker, printing component, vibrating component, etc. I/O ports 118 allow computing device 100 to be logically coupled to other devices including I/O components 120, some of which may be built in. Illustrative components include a microphone, joystick, game pad, satellite dish, scanner, printer, wireless device, etc.

In some embodiments, the computing device 100 of FIG. 1 is configured to implement various aspects of the present invention. In one instance, these aspects relate to providing a user a focused advertising experience during an online computing session. Generally, providing the focused advertising experience involves building a user profile from personal characteristics of a user and for leveraging the user profile to select advertisements that focus on interests of the user.

In general, embodiments of the present invention provide for selection and presentation of relevant advertisements. As utilized herein, the term “advertisement” is not meant to be limiting. For instance, the term advertisement could relate to a promotional communication between a seller offering goods or services to a prospective purchaser of such goods or services. In addition, the advertisement could contain any type or amount of data that is capable of being communicated for the purpose of generating interest in, or sale of, goods or services, such as text, animation, executable information, video, audio, and other various forms. By way of example, the advertisement may be configured as a digital image that is published within an advertisement space allocated within a UI display. In the instance described above, the UI display is rendered by a web browser or other application running on a client device.

Other embodiments of the present invention relate to a process for extracting personal characteristics from a media file, where the personal characteristics are used to guide selection of the advertisements designated for a particular user. As utilized herein, the phrase “personal characteristics” is not meant to be construed as limiting, but may encompass any information about a user that can be both distilled from a media file and applied for the purpose of selecting an advertisement. By way of example, personal characteristics encompass personal attributes of the user (e.g., hobbies, occupation, travel propensity, and the like), statistical data of the user (e.g., address, family aspects, living arrangements, income bracket, and the like), possessions of the user (e.g., pets, type of car, favorite apparel, and the like), events in which the user is involved (e.g., birthdays, anniversaries, etc.), and other miscellaneous information that helps to define the interests of the user.

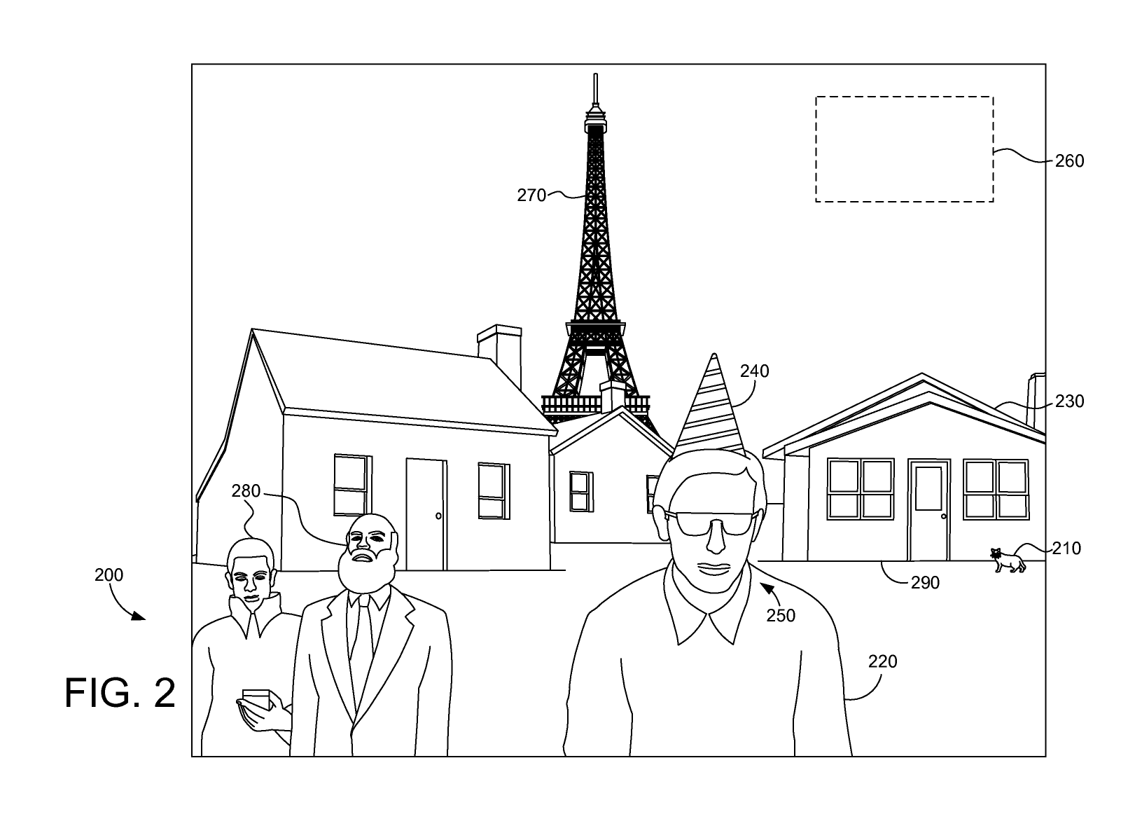

The process of gleaning these personal characteristic from media files will now be discussed with reference to FIG. 2. Generally, FIG. 2 is an illustrative digital image 200 that shows features 210, 220, 230, 240, 250, 270, and 280, and indirect evidence 260 and 290 of features within exemplary content of the digital image 200. The digital image 200 is provided in accordance with one embodiment of the present invention. That is, although the digital image 200 is presented for discussion purposes, various other types of media files may be accessed and scanned to detect personal characteristics of a user associated therewith. For instance, the media files may encompass any one or more of the following items: digital images, videos, audio files, email messages, and online or local documents. Although various different configurations of the media files have been described, it should be understood and appreciated that other types of suitable digital media that provide an indication of a user's interests may be used, and that embodiments of the present invention are not limited to those types of digital media described herein.

In addition, the media files may be accessed in a variety of storage locations. For instance, these storage locations may reside locally on a client device in the possession of the user, wherein the storage locations include internal folders, CD memory, external flash drives, etc. In another instance, the storage locations may relate to online space accommodated by remote web servers, where the storage locations are accessible via an online photo album (i.e., a website where the user is responsible for managing the media files), a networking site, or a public database (e.g., Virtual Earth™) that hosts a collection of public media files.

Returning to FIG. 2, the feature 210 represents a pet, and specifically a cat in this illustration. In embodiments, distilling the pet feature 210 from the digital image 200 involves scanning the digital image 200 to detect features that are exhibited within the content of the digital 200 and applying a set of classifiers to identify the pet feature 210 from the detected features. Accordingly, each classifier in the set of classifiers is configured to recognize a distinct type of feature, such as the pet feature 210. In particular, recognizing the pet feature 210 from other features may involve segmenting a candidate feature, or object, found in the content of the digital image 200 into fragments and ascertaining whether the fragments correspond with predefined, class-specific features of pets. Further, object boundaries may be realized from the candidate feature and compared with shapes known to be associated with pets. These and other suitable methods for detecting particular classes of features are described in, for example, Shimon Ullman, Object Recognition and Segmentation by a Fragment-based Hierarchy, 11(2) TRENDS IN COGNITIVE SCIENCES, 58-64 (2007).

Upon identifying the candidate feature as the pet feature 210, the pet feature 210 may be analyzed to determine those personal characteristics that relate to the pet feature 210. Generally, the personal characteristic of “humanitarian” may be abstracted from the presence of the pet feature 210 in the digital image 200. If, based on analysis of other media files associated with the user, the pet feature 210 is identified a predefined threshold number of times, or occurs at a particular frequency, the personal characteristic of “pet owner” may be abstracted.

The feature 220 represents a subject of the digital image 200, and specifically a young male in this illustration. In embodiments, distilling the subject feature 220 from the digital image 200 involves scanning the digital image 200 to detect which features are identified as people and which person of the identified people is predominate. In instances, predominance is based on geometric parameters such as size, shape, and proximity to a central point of the digital image 200.

If, based on the subject feature 220, it is determined that the user initially associated with the digital image 200 is also the predominate subject of the digital image 200, the digital image 200 is tagged with metadata to articulate this determination. Further, when the user initially associated with the digital image 200 is also the predominate subject of the digital image 200, those personal characteristics that are abstracted from the digital image 200 may be confidently assumed to reflect interests of the user. Accordingly, these abstracted personal characteristics (e.g., humanitarian and pet owner) may by incorporated into a user profile assigned to the user, as opposed to user profiles assigned to other persons appearing in the digital image 200.

The feature 250 represents a face of the subject of the digital image 200. Generally, the face feature 250 is useful in abstracting the personal characteristics of, at least, age and gender from the digital image 200. Initially, in embodiments, the face feature 250 may be identified from the other features of the digital image 200 by detecting a shape and attributes of a nearly frontal face using any object recognition method. Once the face feature 250 is identified, the age of the subject may be estimated with a high degree of accuracy. Estimating the age may, for example, include the steps of generating statistical models of facial appearance for a plurality of age brackets, apply the set of classifiers to obtain a parametric description of the face feature 250, and iteratively comparing the parametric description of the face feature 250 with each of the statistical models until a best match is established. Accordingly, the age bracket associated with the best matching statistical model is used to estimate the age of the subject. The estimated age of the subject is then incorporated into the subject's user profile as a personal characteristic of the subject. These and other suitable methods for abstracting ages from features in digital images are described in, for example, Andreas Lanitis, Christina Draganova & Chris Christodoulou, Comparing Different Classifiers for Automatic Age Estimation, 34(1) IEEE TRANSACTIONS ON SYSTEMS, MAN, AND CYBERNETICS, 621-628 (2004).

Further, once the face feature 250 is identified, the gender of the subject may be abstracted therefrom. Abstracting the gender may, for example, include the step of employing independent component analysis (ICA) to the face feature 250 in order to derive feature vectors from the facial features (e.g., eyes, nose, ears, hair, mouth, cheeks, and the like) of the nearly frontal face. In addition, abstracting the gender may include invoking an algorithmic analysis of the feature vectors in a low-dimension subspace to arrive at the gender of the subject. The gender of the subject is then incorporated into the subject's user profile as a personal characteristic of the subject. These and other suitable methods for abstracting gender from features in digital images are described in, for example, Amit Jain & Jeffrey Huang, Integrating Independent Components and Support Vector Machines for Gender Classification, PROCEEDINGS OF THE 17TH INTERNATIONAL CONFERENCE ON PATTERN RECOGNITION, 558-561 (2004).

The feature 270 represents a landmark (i.e., Eiffel Tower) that assists in abstracting such personal characteristics as residence and propensity to travel, which are persisted in a travel profile that is discussed more fully below. The landmark feature 270 may be identified by identifying an object in the digital image 200 as a structure, and comparing distinctive attributes of the structural object to pronounced aspects of known landmarks. If, based on the comparison, there is a substantial match between the structural object and one of the known landmarks, the landmark feature 270 is identified and the appropriate personal characteristics are added to the subject's user profile.

The travel profile may be developed and updated using such features as the landmark feature 270. Initially, in one instance, developing the travel profile includes associating location data with the subject of the digital image 200, where the location data includes a global location indicated by the landmark feature 270 (i.e., Paris) and/or a GPS location embedded into the digital image 200 as indicated by reference numeral 260. Developing the travel profile may further involve the steps of periodically aggregating the location data and analyzing the aggregation to recognize travel trends based on the location data and timestamps appended to these media files from which the location data is obtained. The travel profile may be persisted in cooperation with the user profile associated with the subject. Further, the travel profile may be conducive to abstracting such personal characteristics as occupation and income bracket from the digital image 200.

As mentioned immediately above, reference numeral 260 is related to a GPS location embedded in the digital image 200. Often, devices with GPS capability (e.g., digital camera, cell phones, PDA's, and other mobile devices) that produce media files (e.g., the digital image 200) automatically integrate the GPS location 260 of the device into the media file upon production thereof. In operation, the GPS location 260 may be indirect evidence of a feature, such as whether the subject of the digital image 200 is at home or on vacation. Further, as discussed above, the location data used for developing the travel profile may be inferred from the GPS location 260.

Even further, the GPS location 260 may be used to associate the digital image 200 with one or more users if there exists no initial association between the digital image 200 and the users. For instance, the digital image 200 may be a streetside image maintained in a public database that was not originated by any of the users. The GPS location 260 embedded in the streetside image (i.e., as a exchangeable image file format) may be compared against the users' personal characteristics, such as residence and travel destinations, to make a determination of whether one or more of the users may be substantially associated with the streetside image, a potential subject of the streetside image, or not associated with the streetside image. Beyond the GPS location 260, other features or indirect evidence of features may be used to associate a media file with a user where no prior connection is established. In one instance, where the media file is a streetside image, the association may be made by inferring the location data from the streetside image and ascertaining that the location data corresponds with one or more personal characteristics established for the user. By way of example, inferring the location data from the streetside image may involve recognizing an address attached to a structure feature 230 or recognizing the landmark feature 270 within the streetside image.

In another instance, where the media file is the digital image 200 accessed in an online photo album that is not controlled by the user, the association between the user and the digital image 200 may be made by mapping features (e.g., the people feature 280), which are detected in the digital image 200 and identified as people, to images of the user. These images of the user may be gleaned from media files that are known to be associated with the user. Accordingly, collecting features from both media files that are originally associated with the user and media files that are newly associated with the user (utilizing the association methods discussed above) extends the quantity of collected features and enables an abstraction of robust personal characteristics of the user. Consequently, the user profile that persists the robust personal characteristics accurately reflects the user's interests and provides a reliable guide for selecting advertisements for the user.

In yet another instance, associations between media files and users may be made by establishing an equivalence relation therebetween. In an exemplary embodiment, a first set of media files that is preassociated with a subject thereof is provided. By way of clarification, in this embodiment, the subject of the first set of media files is synonymous with the user. Next, a second set of media files is inspected to enumerate subjects and other persons that appear in each of the second set of media files. The subject of the first set of media files may be interrogated against at least one of the enumerated subjects and/or others to determine whether a match occurs. When a match occurs, the equivalence relation is established between the subject of the first set of media files and a portion of the second set of media files in which the subject appears. Accordingly, personal characteristics may be abstracted from media files in the second set and these personal characteristics may be used to update the subject's user profile.

Besides linking media files with users, the people feature 280 may be further applied to determine whether an “event” is occurring in the media file. That is, the presence of the people feature 280, alongside the subject of the digital image 200, provides a good indication that some sort of celebration is being conducted. If actors within the people feature 280 are identified, a type of event may be identified. By way of example, the people feature 280 illustrated in FIG. 2 depicts a father and son of the subject. Accordingly, in this example, the people feature 280 may limit the possible events occurring in the digital image 200 to those that are family orientated, such as family reunion vacations, birthdays, weddings, some holidays, etc.

By way of clarification, as used herein, the term “event” is not meant to be construed as limiting, but may encompass any occasion, significant or otherwise, that occurs with some regularity. For instance, some events may repeat annually, such as holidays, wedding anniversaries, and birthdays. Accordingly, by writing these events to the user's user profile, an ad-selection service can predict with accuracy upcoming events and select advertisements that appropriately target the upcoming events in a timely fashion. By way of example, assuming arguendo that a birthday event is upcoming in the near future, the ad-selection service will be guided by the user profile to begin selecting advertisements that relate to birthday products and services in advance of the birthday.

In one embodiment, upon ascertaining that a group of media files were generated within a predefined time frame (e.g., utilizing a timestamp embedded into the media files), the group may point to the presence of an event. By way of example, the predetermined time frame may comprise a span of time that extends the duration of an afternoon, a day, or a weekend. Further, the group of media files may be used to identify the participants of the event. In one instance, identifying the participants of the event may comprise applying a set of classifiers to enumerate those subjects that appear in the group of media files with the highest level of frequency. Accordingly, the event may be linked to user profiles associated with each of the subjects. Again the set of classifiers may be applied to identify a member of the subjects that appears most frequently in the group of media files. This identified member is typically designated as the owner of the event and is the primary focus of event-related advertisements when the event is within close temporal proximity.

Further, upon detecting the event and its participants, a topic or identity of the event may be determined by scanning the group of media files associated with the event and detecting features embodied within each of the media files within the group. Accordingly, the topic of the event may be identified by analyzing the detected features. By way of example, as illustrated by FIG. 2, the feature 240 represents a party hat. The party-hat feature 240 may be detected and identified as such with respect to other objects in the digital image 200. Upon analysis, a list of all possible events may be filtered down to the events that naturally include the party-hat feature 240 (e.g., certain holidays, festivals, and birthdays). Further, the analysis may select the topic of the event from those that naturally include the party-hat feature 240 by identifying a type of event that most closely correlates to the party-hat feature 240. In this example, the selected topic of the event is likely a birthday.

Based on the topic of the event, a frequency at which the event occurs may be deduced. For instance, if the topic of the event is a birthday, then frequency may be annual. If no topic is associated with the event, the frequency may be deduced from a length of a time period between the event and another event with a similar topic and with similar participants. Advantageously, the selection of advertisements that are relevant to the event may be aligned with the frequency at which the event occurs, thereby presenting the owner of the event with very relevant advertised products and services.

The feature 230 representing a structure relates to objects, such as houses, apartments, commercial buildings, restaurants, etc., that appear in the digital image 200. In some cases, the structure feature 230 can be identified as a primary residence of the subject if the same structure feature 230 appears in a predefined number, or certain frequency, of media files associated with the subject. Various personal characteristics of the subject of the digital image 200 may be abstracted with confidence from the structure feature 30. Examples of these personal characteristics may include residence, homeowner vs. renter, urban vs. rural, income bracket, marital status, and spending habits.

Although various different features and methods for detecting/identifying those features from media files have been described, it should be understood and appreciated that other types of features and suitable procedures for recognizing those features may be used, and that embodiments of the present invention are not limited to those exemplary methods and features described herein. For instance, the indirect evidence 290 of the feature relating to subject height may be gleaned from a ground plane. The ground plane may be derived from a ground plane estimation algorithm that takes into account a direction in which a camera is pointing when capturing the digital-image contents. As such, the size and position of the subject in the digital image 200, in the context of the ground plane, may facilitate determining the height-of-the-subject feature. Such personal characteristics as age and gender may be abstracted from the height-of-the-subject feature.

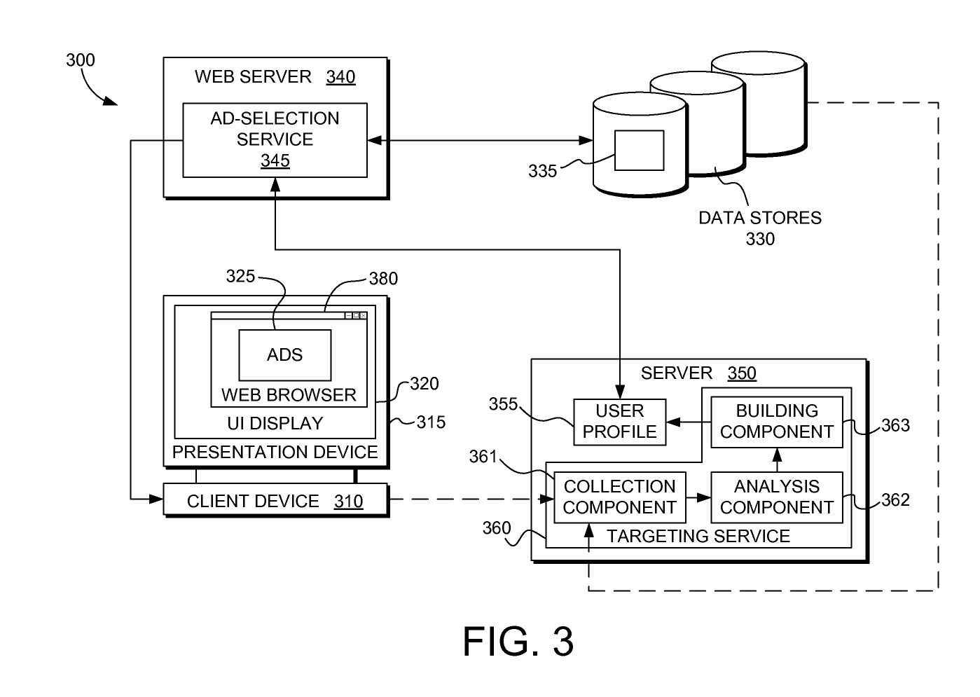

The system architecture for implementing the method of personalizing selection of advertisements based on digital image-analysis will now be discussed with reference to FIG. 3. Initially, FIG. 3 is a block diagram illustrating a distributed computing environment 300 suitable for use in implementing embodiments of the present invention. The exemplary computing environment 300 includes a client device 310, data stores 330, a web server 340, a server 350, and a network (not shown) that interconnects each of these items. Each of the client device 310, the data stores 330, the web server 340, and the server 350, shown in FIG. 3, may take the form of various types of computing devices, such as, for example, the computing device 100 described above with reference to FIG. 1. By way of example only and not limitation, the client device 310, the web server 340, and/or the server 350 may be a personal computer, desktop computer, laptop computer, consumer electronic device, handheld device (e.g., personal digital assistant), various servers, processing equipment, and the like. It should be noted, however, that the invention is not limited to implementation on such computing devices but may be implemented on any of a variety of different types of computing devices within the scope of embodiments of the present invention.

Typically, each of the client device 310, the web server 340, and the server 350 includes, or is linked to, some form of a computing unit (e.g., central processing unit, microprocessor, etc.) to support operations of the component(s) running thereon (e.g., collection component 361, analysis component 362, building component 363, and the like). As utilized herein, the phrase “computing unit” generally refers to a dedicated computing device with processing power and storage memory, which supports operating software that underlies the execution of software, applications, and computer programs thereon. In one instance, the computing unit is configured with tangible hardware elements, or machines, that are integral, or operably coupled, to the client device 310, the web server 340, and the server 350 to enable each device to perform communication-related processes and other operations (e.g., employing the ad-selection service 345 to access a user profile 355 and filter advertisements 335 based on the user profile 355). In another instance, the computing unit may encompass a processor (not shown) coupled to the computer-readable medium accommodated by each of the client device 310, the web server 340, and the server 350.

Generally, the computer-readable medium includes physical memory that stores, at least temporarily, a plurality of computer software components that are executable by the processor. As utilized herein, the term “processor” is not meant to be limiting and may encompass any elements of the computing unit that act in a computational capacity. In such capacity, the processor may be configured as a tangible article that processes instructions. In an exemplary embodiment, processing may involve fetching, decoding/interpreting, executing, and writing back instructions.

Also, beyond processing instructions, the processor may transfer information to and from other resources that are integral to, or disposed on, the client device 310, the web server 340, and the server 350. Generally, resources refer to software components or hardware mechanisms that enable the client device 310, the web server 340, and the server 350 to perform a particular function. By way of example only, a resource accommodated by the web server 340 includes an ad-selection service 345, while a resource accommodated by the server 350 includes a targeting service 360.

The client device 310 may include an input device (not shown) and a presentation device 315. Generally, the input device is provided to receive input(s) affecting, among other things, search results and advertisement display 325 rendered by a web browser 380 surfaced at a UI display 320. Illustrative devices include a mouse, joystick, key pad, microphone, I/O components 120 of FIG. 1, or any other component capable of receiving a user input and communicating an indication of that input to the client device 310. By way of example only, the input device facilitates entry of a query that indicates to the ad-selection service 345 that an opportunity to present the advertisement display 325 exists.

In embodiments, the presentation device 315 is configured to render and/or present the UI display 320 thereon. The presentation device 315, which is operably coupled to an output of the client device 310, may be configured as any presentation component that is capable of presenting information to a user, such as a digital monitor, electronic display panel, touch-screen, analog set-top box, plasma screen, audio speakers, Braille pad, and the like. In one exemplary embodiment, the presentation device 315 is configured to present rich content, such as the advertisement display 325 and digital images. In another exemplary embodiment, the presentation device 315 is capable of rendering other forms of media (i.e., audio signals).

The data stores 330 are generally configured to store information associated with the advertisements 335 that may be selected or filtered by the ad-selection service 345 (e.g., AdCenter). In various embodiments, such information may include, without limitation, advertisements 335 that are supplied by ad-providers who are customers of the ad-selection service 345. In addition, the data stores 330 may be configured to be searchable for suitable access to the stored advertisements 335. For instance, the data stores 330 may be searchable for one or more of the advertisements 335 that are targeted toward interests of a user, where the targeting is based on the user profile 355. It will be understood and appreciated by those of ordinary skill in the art that the information stored in the data stores 330 may be configurable and may include any information relevant to the storage or, access to, and retrieval of the advertisements 335 for placement in ad space on the UI display 320. The content and volume of such information are not intended to limit the scope of embodiments of the present invention in any way. Further, though illustrated as single, independent components, the data store(s) 330 may, in fact, be a plurality of databases, for instance, a database cluster, portions of which may reside on the client device 310, the server 350, the web server 340, another external computing device (not shown), and/or any combination thereof.

This distributed computing environment 300 is but one example of a suitable environment that may be implemented to carry out aspects of the present invention and is not intended to suggest any limitation as to the scope of use or functionality of the invention. Neither should the illustrated distributed computing environment 300 be interpreted as having any dependency or requirement relating to any one or combination of the devices 310, 340, and 350, the storage devices 330, and components 361, 362, and 363 as illustrated. In some embodiments, one or more of the components 361, 362, and 363 may be implemented as stand-alone devices. In other embodiments, one or more of the components 361, 362, and 363 may be integrated directly into the server 350, or on distributed nodes that interconnect to form the web server 340. It will be appreciated and understood that the components 361, 362, and 363 (illustrated in FIG. 3) are exemplary in nature and in number and should not be construed as limiting.

Accordingly, any number of components may be employed to achieve the desired functionality within the scope of embodiments of the present invention. Although the various components of FIG. 3 are shown with lines for the sake of clarity, in reality, delineating various components is not so clear, and, metaphorically, the lines would more accurately be grey or fuzzy. Further, although some components of FIG. 3 are depicted as single blocks, the depictions are exemplary in nature and in number and are not to be construed as limiting (e.g., although only one presentation device 315 is shown, many more may be communicatively coupled to the client device 310).

Further, the devices of the exemplary system architecture may be interconnected by any method known in the relevant field. For instance, the client device 310, the web server 340, and the server 350 may be operably coupled via a distributed computing environment that includes multiple computing devices coupled with one another via one or more networks (not shown). In embodiments, the network may include, without limitation, one or more local area networks (LANs) and/or wide area networks (WANs). Such networking environments are commonplace in offices, enterprise-wide computer networks, intranets, and the Internet. Accordingly, the network is not further described herein.

In operation, the components 361, 362, and 363 are designed to perform a process that includes, at least, automatically building and maintaining the user profile 355 by analyzing content of one or more media files. Initially, the collection component 361 is configured for accessing a gallery of media files associated with the user who is actively involved in a computing session on the client device 310. The gallery of media files may be locally stored (e.g., at the client device 310) or may be remotely stored (e.g., at the data stores 330). Upon accessing the storage locations that persist the media files associated with the user, the collection component 361 passes the media files to the analysis component 362 for processing.

Generally, the analysis component 362 is configured for scanning the media files to detect features expressed by the content thereof, and for abstracting personal characteristics of the user from the media files by analyzing the detected features. These procedures are described more fully above with respect to FIG. 2. Upon abstracting the personal characteristics that reflect the user's current interests, the personal characteristics are passed to the building component 363. The building component is configured to write the personal characteristics to the user profile 355 that is associated with the user. As discussed above, the personal characteristics of the user profile 355 are employed to guide the ad-selection service 345 to select advertisements that target the interests of the user.

The cooperative operation of the components 361, 362, and 363 support, in part, the functionality of the targeting service 360. Beyond constructing the user profile 355, the targeting service 360 is configured to carry out a plurality of varied processes. Examples of these processes include updating the user profile 355 and reaffirming the accuracy of the user profile 355 with the user. In embodiments, updating the user profile 355 includes the steps of ascertaining whether additional media files exist that and ascertaining whether the additional media files are associated with the user conducting the computing session on the client device 310. If both these conditions are met (i.e., additional media files exist are associated with the user), additional personal characteristics of the user are abstracted from the additional media files by analyzing features detected therein. The targeting service 360 then employs the building component 363 to update the user profile 355 by writing the additional personal characteristics thereto.

Another process conducted by the targeting service 360 involves reaffirming the accuracy of the user profile 355 with the user. Reaffirming initially includes exposing the personal characteristics written to the user profile 355 to the user associated with the user profile 355. Exposing may comprise presenting the personal characteristics to the user in the form of a digital document or communication to the user in an email message. The process of reaffirming accuracy may also include the procedures of receiving feedback from the user, where the feedback rates the accuracy of the personal characteristics, and updating the user profile 355 i.e., utilizing the building component 363) by incorporating the feedback thereto.

The web server 340 is depicted as accommodating the ad-selection service 345. In embodiments, the ad-selection service 345 may be managed by the same entity that manages the targeting service 360, by the ad-providers, or by a third party. In other embodiments, the ad-selection service 345 may reside in full or in part on the server 350 or on the client device 310.

In operation, the ad-selection service 345 performs various actions that pertain to selecting and distributing one or more of the advertisements 335 that are accessible to the web server 340. One of the actions involves utilizing the abstracted personal characteristics to influence which of the advertisements 335 are selected for presentation to the user. A second action involves communicating instructions to the client device 310 to publish the selected advertisements 325 at the user UI display 320 rendered by the web browser 380. A third action involves refraining from posting advertisements that are deemed inappropriate (e.g., advertisements with content directed toward mature audiences based on the user profile 355.

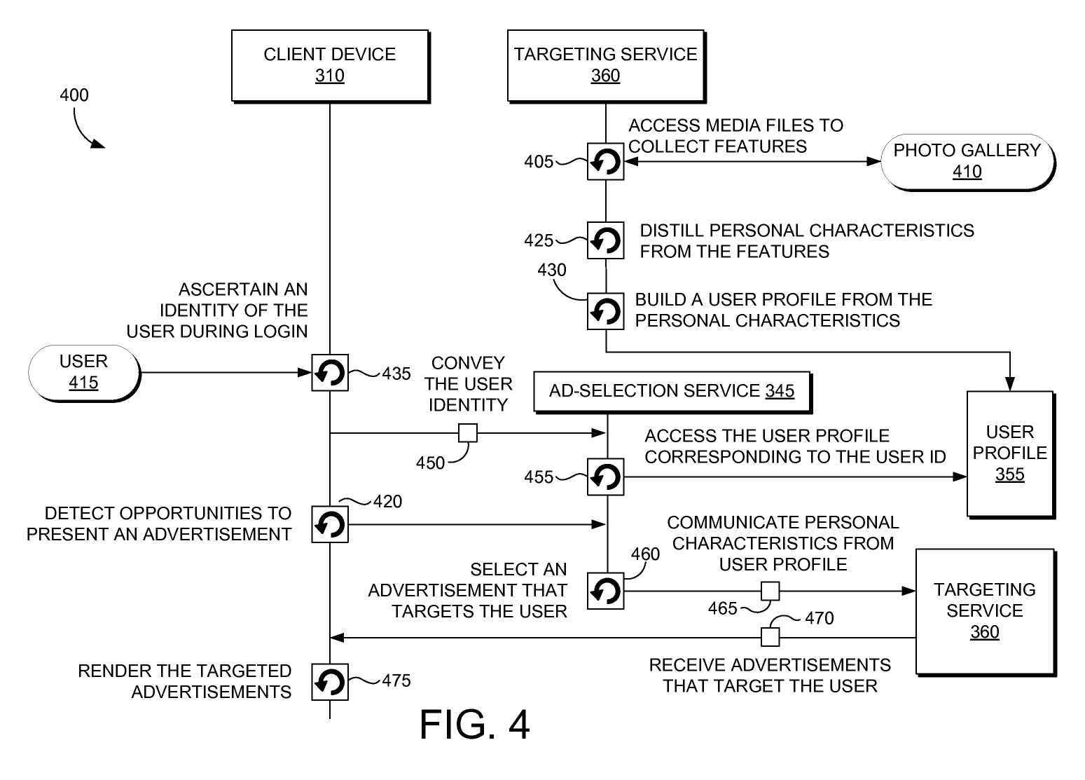

Turning now to FIG. 4, an operational flow diagram 400 of one embodiment of the present invention is shown. Generally, FIG. 4 illustrates a high-level overview of techniques for building the user profile 355 from personal characteristics of a user 415 and for leveraging the user profile 355 to select advertisements that focus on interests of the user 415. Although the terms “step,” “operation,” and/or “block” may be used herein to connote different elements of methods employed, the terms should not be interpreted as implying any particular order among or between various steps herein disclosed unless and except when the order of individual steps is explicitly described.

The exemplary flow diagram 400 commences with the targeting service 360 performing an operation 405 that accesses media files in order to collect features therefrom. In one instance, the media files are collected from a remote or local photo gallery 410. As depicted at operation 425, personal characteristics are distilled from the collected features (e.g., utilizing an abstraction algorithm). These personal characteristics may be used to build the user profile 355, as depicted at operation 430.

At some time, the user 415 may commence a computing session on the client device 310. When logging into the computing session, or at some time during the session, an identity 450 of the user 415 may be ascertained. This is depicted at operation 435. The identity 450 of the user 415 may be conveyed from the client device 310 to the ad-selection service 345 for use in selecting the user profile 355 that corresponds with the identity 450. This is indicated at operation 455.

Eventually, as depicted at operation 420, the client device 310 will communicate to the ad-selection service 345 that an opportunity to present an advertisement is detected. Consequently, the ad-selection service 345 will implement operation 460 that selects an advertisement that targets the user 415. Selecting the targeting advertisement involves communicating the personal characteristics 465 of the user profile 355 to the targeting service 360 and receiving from the targeting service 360 advertisements 470 that target the user 415. These advertisements 470 may be conveyed to the client device 310, which is configured to render the targeted advertisements 470. This is depicted at operation 475.

In addition to selecting the advertisements 470 based on the personal characteristics 465 of the user 415, the ad-selection service 345 is configured to execute a selection scheme that ascertains which of the advertisements are most appropriate based on various criteria. By way of example, the personal characteristics 465 of the user 415 are a first criteria considered by the selection scheme. A second criteria that may be considered by the selection scheme includes a user-influenced filter that is configured to preference advertisements based on user interests supplied by the user 415. A third criteria that may be considered by the selection scheme comprises a level of relevance between a query submitted by the user 415 and advertisements.

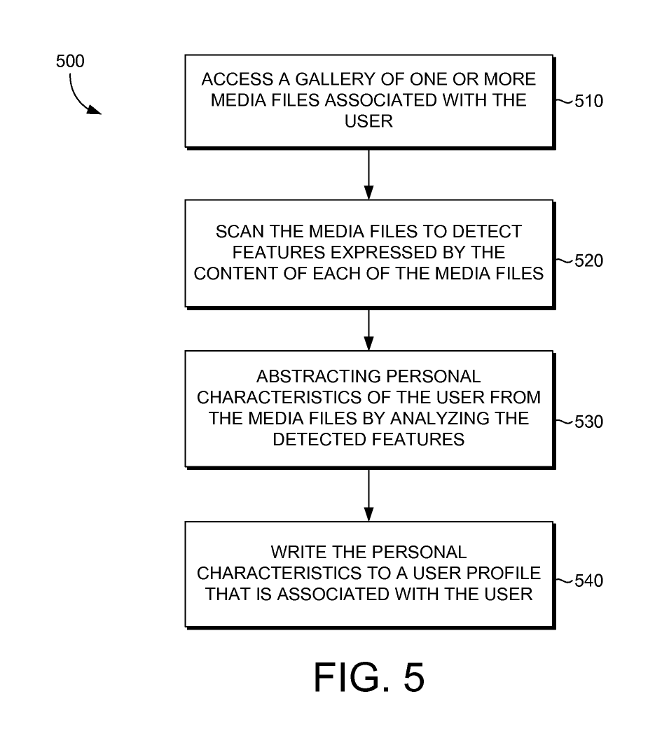

Turning now to FIG. 5, a flow diagram illustrating an overall method 500 for automatically building and maintaining a user profile by analyzing content of one or more media files is shown, in accordance with an embodiment of the present invention. Initially, the method 500 includes the step of accessing a gallery of the media files (e.g., online photo album constructed by the user or streetside images that are publicly available), which are associated with the user, as depicted at block 510. Incident to accessing the gallery, the media files are scanned to detect features expressed by the content of each of the media files, as depicted at block 520. In one instance, the process of scanning includes the steps of applying a set of classifiers to reveal objects in the content and comparing the objects against statistical models for the purposes of identifying the objects as one or more features.

The method 500 further includes abstracting personal characteristics of the user from the media files by analyzing the detected features, as depicted at block 530. These personal characteristics may be written to a user profile that is associated with the user, as depicted at block 540. Generally, the personal characteristics of the user profile are employed to select advertisements that target interests of the user.

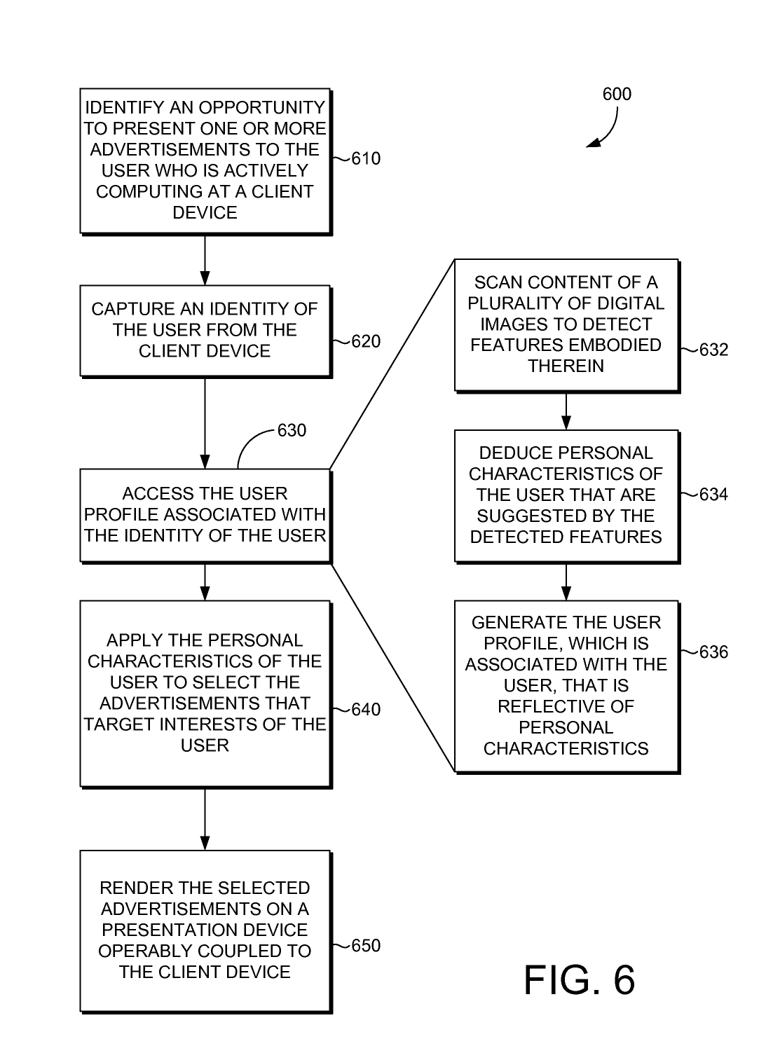

With reference to FIG. 6, a flow diagram illustrating an overall method 600 for employing a user profile to select one or more advertisements that target interests of a user who is associated with the user profile is shown, in accordance with an embodiment of the present invention. The method 600 includes a step of identifying an opportunity to present advertisements to the user while the user is currently involved in an online computing session at a client device (e.g., laptop computer, PDA, mobile device, and the like). As depicted at block 620, an identity of the user is captured from the client device. Based on the user identity, the user profile associated with the identity of the user is accessed, as depicted at block 630.

In embodiments, the user profile is constructed by a process that includes the following logical steps: scanning content of a plurality of digital images to detect features embodied therein (see block 632); deducing personal characteristics of the user that are suggested by the detected features (see block 634); and generating the user profile (see block 636). Typically, the user profile reflects the personal characteristic and is persisted in association with the user. As depicted at block 640, the personal characteristics of the user are applied to select the advertisements that best target interests of the user. Upon selecting the advertisements, the selected advertisements are rendered on a presentation device that is operably coupled to the client device, as depicted at block 650.

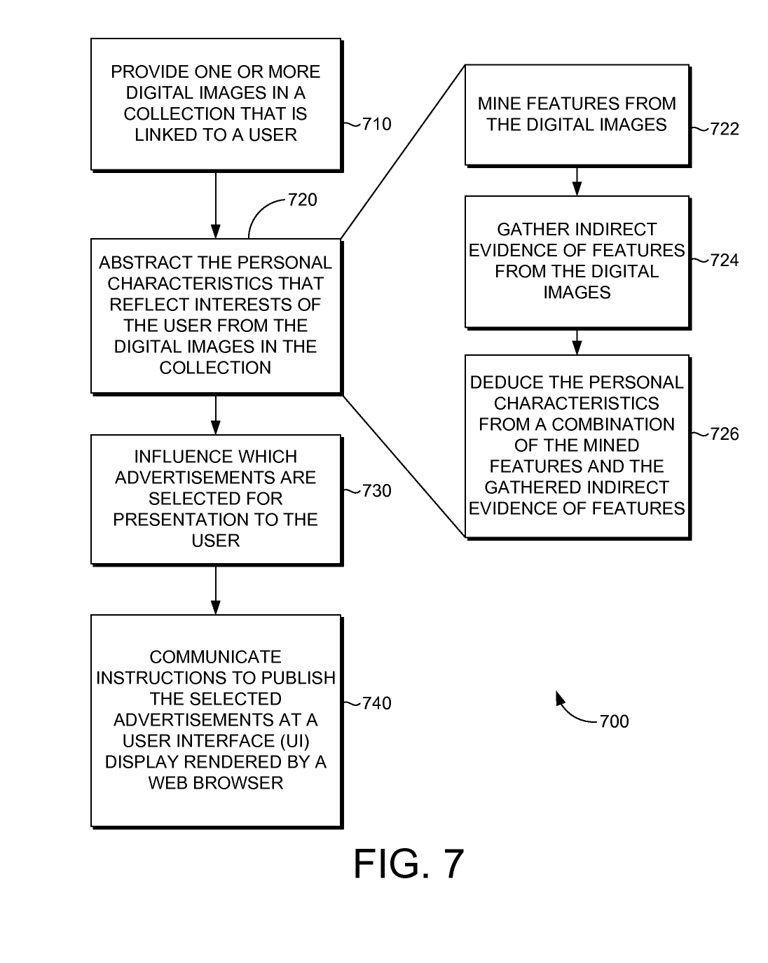

Referring now to FIG. 7, a flow diagram illustrating an overall method 700 for utilizing personal characteristics to facilitate selection of one or more advertisements is shown, in accordance with an embodiment of the present invention. In an exemplary embodiment, the method 700 includes providing one or more digital images in a collection (e.g., online photo album or aggregation of streetside images) that is linked to a user, as depicted at block 710. In instances where the collection is an online photo album or a local folder of digital images, the user is responsible for managing the collection.

When the user is responsible for managing the collection, permission to access the media files within the collection is typically procured. In one instance, procuring a user's permission to access media files under his/her control may involve sending a communication from the ad-selection service to solicit permission from the user to access the media files in the online photo album or the local folder. In other instance, procuring permission may involve offering a waiver to the user upon establishing an online photo album. Accordingly, execution of the waiver provides implicit permission to access the media files uploaded thereto. In yet another instance, the user may be asked to provide an address of storage locations to be used for the purposes of personalizing advertisements to the user's interests and preferences. A response from the user with the address (e.g., URL link) of one or more storage locations serves as inherent authorization to access the media files within the storage locations (e.g., online photo album).

As depicted at block 720, personal characteristics that reflect interests of the user are abstracted from the digital images in the collection. In particular, the process of abstracting includes the following procedures: mining features from the digital images (see block 722); gathering indirect evidence of features from the digital images (see block 724); and deducing the personal characteristics from a combination of the mined features and the gathered indirect evidence of features (see block 726).

By way of clarification, the indirect evidence of features (e.g., the ground plane 290 of FIG. 2) indicates that a specific feature (e.g., the height-of-the-user feature of FIG. 2) is associated with a particular digital image (e.g., the digital image 200 of FIG. 2) even when the specific feature does not explicitly appear within a frame of the particular digital image. As depicted at block 730, these abstracted personal characteristics are utilized to influence which of the advertisements are selected for presentation to the user. Eventually, as depicted at block 740, instructions to publish the selected advertisements at a user interface (UI) display rendered by a web browser are issued.

The present invention has been described in relation to particular embodiments, which are intended in all respects to be illustrative rather than restrictive. Alternative embodiments will become apparent to those of ordinary skill-in-the-art to which the present invention pertains without departing from its scope.

From the foregoing, it will be seen that this invention is one well adapted to attain all the ends and objects set forth above, together with other advantages which are obvious and inherent to the system and method. It will be understood that certain features and sub-combinations are of utility and may be employed without reference to other features and sub-combinations. This is contemplated by and is within the scope of the claims.

The invention claimed is:

1. One or more computer-readable media having computer-executable instructions embodied thereon that, when executed, perform a method for automatically building and maintaining a user profile by analyzing content of one or more media files, the method comprising:
accessing a gallery of the one or more media files associated with the user;
scanning the one or more media files to detect features expressed by the content of each of the one or more media files;
abstracting personal characteristics of the user from the one or more media files by analyzing the detected features; and
writing the personal characteristics to a user profile that is associated with the user, wherein the personal characteristics of the user profile are employed to select information that targets interests of the user.

2. The one or more computer-readable media of claim 1, wherein the method further comprises:
becoming aware of an existence of additional media files;
ascertaining that the additional media files are associated with the user;
abstracting recent personal characteristics of the user from the additional media files by analyzing features detected therein; and
updating the user profile by writing the recent personal characteristics thereto.

3. The one or more computer-readable media of claim 1, wherein accessing a gallery of the one or more media files comprises at least one of inspecting the one or more media files persisted in an online space of a web server, or reviewing the one or more media files persisted in a storage location accommodated by a client device.

4. The one or more computer-readable media of claim 1, wherein scanning the one or more media files to detect features expressed by each of the one or more media files comprises applying a set of classifiers to detect the features that exhibited within the content of a digital image, wherein each classifier in the set of classifiers is configured to recognize a distinct type of feature.

5. The one or more computer-readable media of claim 1, wherein the gallery of the one or more media files comprises an online photo album constructed by the user, and wherein the method further comprises:
automatically soliciting permission from the user to access the online photo album; and
upon the user granting authorization to access the online photo album, commencing processing of the online photo album.

6. The one or more computer-readable media of claim 1, wherein the gallery of the one or more media files further comprises a plurality of streetside images that are publicly available, and wherein the method further comprises:
inferring location data from the plurality of streetside images, wherein the location data is inferred from at least one of an address attached to a structure, a global positioning system (GPS) location embedded in a streetside image, or a landmark within a streetside image that is recognized as having a particular global location; and
associating the user with features detected from at least one of the plurality of streetside images based on the location data.

7. The one or more computer-readable media of claim 6, the method further comprising:
associating the location data with the user;
periodically aggregating the location data to develop a travel profile; and
persisting the travel profile in cooperation with the user profile associated with the user.

8. The one or more computer-readable media of claim 1, the method further comprising:
ascertaining that a group of the one or more media files were generated within a predefined time frame; and
associating the group of media files with an event.

9. The one or more computer-readable media of claim 8, wherein the method further comprises:
applying a set of classifiers to enumerate those subjects that appear in the group of media files with the highest level of frequency;
linking the event to user profiles associated with each of the subjects;
applying the set of classifiers to identify a member of the subjects that appears most often in the group of media files; and
designating the identified member as an owner of the event.

10. The one or more computer-readable media of claim 9, wherein the method further comprises:
detecting features expressed by each of the group of media files;
abstracting a topic of the event by analyzing the detected features;
based on the topic of the event, deducing a frequency at which the event occurs; and
aligning selection of advertisements that are relevant to the event with the frequency at which the event occurs.

11. The one or more computer-readable media of claim 1, wherein the method further comprises:
providing a first set of media files that is preassociated with a subject thereof;
inspecting a second set of media files to enumerate those subjects that are expressed by each of the second set of media files;
interrogating the subject of the first set of media files against the enumerated subjects to determine whether a match occurs; and
when a match occurs, establishing an equivalence relation between the subject of the first set of media files and a portion of the second set of media files in which the subject appears.

12. The one or more computer-readable media of claim 1, wherein the method further comprises:
exposing the personal characteristics written to the user profile to the user associated with the user profile;
receiving feedback from the user that pertains to the accuracy of the personal characteristics; and
updating the user profile by incorporating the feedback thereto.

13. A computerized method, implemented at a processing unit, for employing a user profile to select one or more advertisements that target interests of a user who is associated with the user profile; the method comprising:
identifying an opportunity to present one or more advertisements to the user who is actively computing at a client device;
capturing an identity of the user from the client device;
accessing the user profile associated with the identity of the user, wherein the user profile is constructed by a process comprising:
(a) scanning content of a plurality of digital images to detect features embodied therein;
(b) deducing personal characteristics of the user that are suggested by the detected features; and
(c) generating the user profile, which is associated with the user, that is reflective of personal characteristics;
applying the personal characteristics of the user to select the one or more advertisements that target interests of the user; and
rendering the one or more selected advertisements on a presentation device operably coupled to the client device.

14. The computerized method of claim 13, further comprising utilizing a selection scheme to ascertain which of the one or more advertisements are selected, wherein the personal characteristics of the user are a first criteria considered by the selection scheme.

15. The computerized method of claim 14, wherein a second criteria considered by the selection scheme comprises a user-influenced filter that is configured to preference advertisements based on the user interests supplied by the user; and wherein a third criteria considered by the selection scheme comprises a level of relevance between a query submitted by the user and advertisements.

16. The computerized method of claim 13, wherein applying the personal characteristics of the user to select the one or more advertisements that target interests of the user further comprises conveying a representation of the user profile to an ad-selection service, wherein the ad-selection is configured to refrain from posting advertisements that are deemed inappropriate based on the representation of the user profile.

17. The computerized method of claim 13, wherein the processing unit that performs the computerized method of employing the user profile to select the one or more advertisements that target interests of the user resides on at least one of the client devices or a web server within a distributed computing environment.

18. One or more computer-readable media having computer-executable instructions embodied thereon that, when executed, perform a method for utilizing personal characteristics to facilitate selection of one or more advertisements, the method comprising:
providing one or more digital images in a collection that is linked to a user, wherein the user is responsible for managing the collection;
abstracting the personal characteristics that reflect interests of the user from the one or more digital images in the collection, wherein the process of abstracting comprises:
(a) mining features from the one or more digital images;
(b) gathering indirect evidence of features from the one or more digital images, wherein the indirect evidence of features indicates that a specific feature is associated with a particular digital image even when the specific feature does not explicitly appear within a frame of the particular digital image; and
(c) deducing the personal characteristics from a combination of the mined features and the gathered indirect evidence of features;
utilizing the abstracted personal characteristics to influence which of the one or more advertisements are selected for presentation to the user; and
communicating instructions to publish the one or more selected advertisements at a user interface (UI) display rendered by a web browser.

19. The one or more computer-readable media of claim 18, wherein the method further comprises receiving from the user a uniform resource locator (URL) link that navigates to the collection of the one or more digital images that are managed by the user.

20. The one or more computer-readable media of claim 18, wherein the gathered indirect evidence of features comprises GPS data in an exchangeable image file format, wherein the GPS data indicates that the specific feature of a geographic location is associated with a particular digital image, and wherein the personal characteristic of a travel profile is deduced, in part, from the geographic location.
